(19) United States
(12) Patent Application Publication
(10) Pub. No.: US 2021/0261098 A1
(43) Pub. Date: Aug. 26, 2021

(54) METHOD AND SENSOR ARRAY FOR TOUCH-FREE WIDTH MONITORING IN VEHICLE TREATMENT INSTALLATIONS

(71) Applicant: WashTec Holding GmbH, Augsburg (DE)

(72) Inventors: Richard KIRCHEIS, Augsburg (DE); Ferdinand CONRAD, Augsburg (DE); Ulrich KÖLBL, Friedberg (DE); Stefan WÖLFE, Augsburg (DE)

(21) Appl. No.: 17/260,618

(22) PCT Filed: Jul. 16, 2019
(86) PCT No.: PCT/EP2019/069170

§ 371 Date: Jan. 15, 2021

(30) Foreign Application Priority Data
Jul. 18, 2018 (DE) 10 2018 117 440.3

(51) Int. Cl. B60S 3/00; B60S 3/04

(52) U.S. Cl. CPC B60S 3/004; B60S 3/047

(57) ABSTRACT

A vehicle treatment system includes at least one treatment device that is movable relative to a vehicle to be treated. The vehicle treatment system also includes a collision detection device for width monitoring of a maximum treatment area of the vehicle treatment system, which for monitoring a lateral boundary of the maximum treatment area has at least one first optical sensor and a control unit for evaluating output values of the first optical sensor. The detection area of the first optical sensor is aligned along a lateral boundary of the maximum treatment area of the vehicle treatment system and the treatment device in the direction of travel leading ahead by a specified distance. The control unit is set such that the control unit detects an imminent collision if a specified number of consecutive cycles is scanned with a covered event.

### CROSS REFERENCE TO RELATED APPLICATIONS

This application is the United States national phase entry of International Application No. PCT/EP2019/069170, filed Jul. 16, 2019, and claims the benefit of priority of German Application No. 10 2018 117 440.3, filed Jul. 18, 2018. The contents of International Application No. PCT/EP2019/069170 and German Application No. 10 2018 117 440.3 are incorporated by reference herein in their entireties.

### FIELD

The invention relates to a vehicle treatment system in which at least one treatment device, in particular a washing gantry, and a vehicle to be treated or washed are moved relative to each other, having a collision detection device for width monitoring of a maximum treatment area of the vehicle treatment system, which, for monitoring a lateral boundary of the maximum treatment area, has at least one first optical sensor which is operated at a predetermined scanning frequency and outputs either a ‘covered’ event or a ‘not covered’ event for each scanning cycle, and a control unit for evaluating the output values of the first optical sensor.

### BACKGROUND

It is a known problem in the field of vehicle treatment systems, in which there is a relative movement between a vehicle to be treated and a vehicle treatment device, that if the vehicle is incorrectly positioned, it can be damaged by a collision with the vehicle treatment device. Vehicle treatment systems, in particular gantry wash systems, which are operated without instruction personnel, therefore usually have a device for monitoring the boundaries of the maximum treatment space. This device is intended to avoid a possible collision of the vehicle treatment system with the vehicle to be treated. A width monitoring device is a device for monitoring the lateral boundaries of the vehicle treatment system or of the maximum passage width. If a vehicle is incorrectly positioned when entering the vehicle treatment system, whereby the boundaries of the maximum passage width are completely or partially exceeded by areas of the vehicle, there is a risk of collision with the vehicle treatment system or parts of it (in the case of a gantry wash system e.g. the gantry columns).

Collision detection devices for vehicle treatment systems are known from the prior art, which use tactile systems or mechanical deflection systems, such as safety edges, pull-wire switches, bending bars or similar devices, in order to prevent such damage. All these systems have in common that in case of contact between the corresponding tactile switching element and the vehicle, a circuit is executed which forces a stop of the relative movement.

However, all of these known solutions have the disadvantage that there is contact albeit weakened between the vehicle and the vehicle treatment device, which may cause damage to the paintwork. Furthermore, such contact-based systems enlarge the vehicle treatment device (in particular in the direction of passage), which is a disadvantage due to the limited space in vehicle treatment systems (which are usually located in halls). Finally, such systems are often perceived as unaesthetic by the customers.

From the prior art, the use of different contactless sensors (mainly in the form of light barriers) for collision monitoring is known and the Applicant has already thought about different contactless solutions in the past. Sensors, which were considered, were based, among other things, on radio/radar technology (continuous wave radar, frequency modulated continuous wave radar) or optical measuring methods (light barrier, time-of-flight, etc.). The first ones have the disadvantage that they only trigger at a certain minimum speed (CW radar, simple Doppler radar), and/or that they have a detection region that is too wide (FMCW). Optical measuring methods, however, have the disadvantage in the area of a vehicle treatment system that they are not triggered correctly due to disturbing influences such as spray mist, water jets or other media. All these sensors, which are classified as potentially suitable, have disadvantages that make reliable operation in the measurement task in hand difficult or even impossible. Tests carried out by the Applicant showed that the interference factors such as spray mist are very similar to the signal of an obstacle in such a way that the signal-to-noise ratio is not sufficient for further filtering.

### SUMMARY

Starting from this problem, the invention is therefore based on the object to provide a contactless collision detection device for a vehicle treatment system, which provides reliable obstacle detection even under adverse conditions in the vehicle treatment system.

According to a first aspect of the invention, a vehicle treatment system is provided in which at least one treatment device and a vehicle to be treated are moved relative to each other. The vehicle treatment system has a collision detection device for width monitoring of a maximum treatment area of the vehicle treatment system. The maximum treatment area is an area of the system in which a vehicle can be positioned so that a collision with the various devices and installations of the vehicle treatment system during the relative movement is excluded. Using a gantry wash system as an example, this could be a projection of the clearance area between the inner edges of the gantry columns in the direction of relative movement. The collision detection device of the vehicle treatment system according to the invention has at least one first optical sensor (e.g. a laser distance sensor or a light barrier) to monitor a lateral boundary of the maximum treatment area, wherein said sensor is operated with a predetermined scanning frequency during a treatment process or during a relative movement between vehicle treatment system and vehicle and outputs a (measured) value, e.g. a measured distance, for each scanning cycle. The collision detection device also has a control unit for the evaluation of the output values of the first optical sensor, which detects the measured values of the sensor (continuously) and for each measuring cycle assigns either a ‘sensor covered’ event (if an irregularity or a potential obstacle is detected) or a ‘sensor not covered’ event (if the measured value corresponds to an expected value without obstacle) to the value output by the first optical sensor. According to the invention, the detection region of the first optical sensor is oriented along a lateral boundary of the maximum treatment area of the vehicle treatment system monitored by the sensor. In particular, the detection region of the first optical sensor can be oriented along a vertical edge or flank of the treatment device limiting the treatment area when viewed in a front view of the vehicle treatment system (or viewed in the direction of relative movement). In addition, the detection region of the first optical sensor is oriented or arranged in such a way that it lies in front of the treatment device by a predetermined distance in the travel direction of the treatment device or precedes it so that there is a sufficient stopping distance if an obstacle is detected. The control unit is set according to the invention in such a way that it detects an impending collision if a predetermined number of consecutive cycles with a ‘covered’ event are scanned or detected at the first optical sensor.

The arrangement according to the invention of an optical sensor for collision monitoring in a vehicle treatment system described above utilizes the advantages of optical sensors by orienting the comparatively sharp (narrow) detection region along a boundary of the maximum treatment area, thus enabling efficient monitoring of this boundary. At the same time, the evaluation of the measurement signals according to the invention allows to compensate the susceptibility of optical sensors to interference factors by adjusting the sensitivity of the first optical sensor over the predetermined number of consecutively scanned cycles with a ‘covered’ event (threshold value).

According to a preferred exemplary embodiment of the invention, the treatment device may be a washing gantry which is moved or movable relative to a vehicle to be washed. In this case, the first optical sensor may be oriented along the inner edge or side of one of the gantry columns (plus a certain safety value, if applicable) to monitor the boundary of the maximum treatment area and to avoid a collision of a vehicle with the gantry column.

According to a further preferred exemplary embodiment of the invention, the control unit can evaluate the output values of the at least one first optical sensor in such a way that the number of consecutive cycles with a ‘covered’ event required to report an impending collision increases the slower the relative movement between the treatment device and the vehicle to be treated is. In other words, the threshold value of consecutive measurement cycles with a ‘sensor covered’ event at the first optical sensor required for obstacle detection can be varied in the course of a treatment, preferably in such a way that the threshold value is increased when the relative movement is slowed down.

Such a control has the advantage that the susceptibility to interference is improved when driving slowly. In particularly critical phases of a vehicle treatment, such as during foam application or in phases in which spray mist is generated, the system can be driven at a correspondingly low speed in order to avoid false triggering of the collision monitoring.

According to a further, preferred aspect of the invention, the collision detection device may comprise, in addition to the first optical sensor, a second optical sensor whose detection region is oriented at a predetermined distance and/or angle to the first optical sensor. In such a sensor array, the control unit can be adapted in such a way that it detects an impending collision at the lateral boundary monitored by the first and the second optical sensor if within a predetermined period of time, in particular simultaneously, a predetermined number of consecutive cycles with a ‘covered’ event is scanned or detected at the first optical sensor as well as at the second optical sensor.

A preferred aspect of the present invention is that the collision detection device can also be used during a treatment, e.g. during a relative movement between vehicle and system and with simultaneous spraying of the vehicle. By the selection and arrangement of the first and/or the second optical sensor according to the invention as well as the evaluation of the measurement results of the sensors according to the invention, collision monitoring can be provided which is less susceptible to interferences and which is fully operational even under the adverse conditions during the operation of a vehicle treatment system. While in the prior art position and orientation detection of the vehicle takes place exclusively before the actual treatment, the invention enables real-time collision monitoring during the treatment and can therefore also detect dangers that occur only after the vehicle is parked (e.g. persons or objects in the moving range).

As additional measures for improving the susceptibility to interference of the collision detection device, a predetermined sensor array can be used in the area of a boundary of the maximum treatment area to be monitored together with redundancy in the sensors.

According to a further, preferred exemplary embodiment of the invention, the detection region of the second optical sensor may be oriented along the same lateral boundary of the maximum treatment area as the detection region of the first optical sensor and also be oriented a predetermined distance ahead of the gantry but a predetermined distance behind the detection region of the first optical sensor in the travel direction. In other words, both redundant sensors may be oriented along the same lateral boundary of the maximum treatment area of the vehicle treatment system, but with a different advance in the direction of relative movement. This has the advantage that both sensors can be oriented exactly along the lateral boundary, but do not overlap in their detection region due to the different advances. In such an embodiment of the invention, the number of consecutive cycles required for reporting an impending collision with a ‘covered’ event at the second optical sensor (located/aligned closer to the treatment device) may preferably be less than the number of consecutive cycles required for reporting an impending collision at the first optical sensor. In other words, with a sensor array as described above, it is advantageous if the different advance between the two sensors is reflected in the threshold value for the required number of consecutive measurement cycles with ‘covered’ event, so that an obstacle detection is faster than with the first sensor, corresponding to the lower advance at the second sensor.

According to an alternative, preferred exemplary embodiment of the invention, the detection region of the second optical sensor, viewed in the direction of relative movement of the vehicle treatment system, can be located approximately at the level of the detection region of the first optical sensor and, viewed from the detection region of the first optical sensor, can be offset inwards towards the center of the treatment area by a predetermined distance. In such an arrangement, the first and second optical sensors are not aligned in the direction of relative movement but are arranged transversely to it (in the width direction of the vehicle treatment system). This has the advantage that it is not necessary to compensate for different advances between the two sensors.

According to a further, preferred aspect of the invention, the control unit can detect an impending collision if the number of consecutive cycles required for reporting an impending collision is simultaneously available at the first optical sensor and at the second optical sensor.

According to a further, preferred exemplary embodiment of the invention, the first and the second optical sensor can be arranged in such a way that the first and/or the second optical sensor are arranged on a cantilever arm on the treatment device, in particular at the level of the cross beam in a gantry wash system, and their detection region extends vertically downwards as seen from there. The sensors can thus measure vertically downwards from a cantilever arm and over the entire height of the treatment area.

According to another, preferred exemplary embodiment of the invention, the first and second optical sensors can be tilted in the travel direction away from the gantry to achieve the predetermined advance in the travel direction of the gantry. The advance orientation of the detection region of the sensors can thus be achieved either by positioning the sensors at a certain angle or by placing them on one or more cantilever arms. In this way, the collision detection can be placed unobtrusively directly in a front of the treatment device or in the upper part of the system.

According to a further, preferred exemplary embodiment of the invention, the first optical sensor and/or the second optical sensor can be a laser distance sensor. Compared to e.g. light barriers, these have the advantage that not only the presence of an obstacle is output, but also the absolute distance to it. This makes it possible to block out certain areas, e.g. permanently installed obstacles such as wheel guide rails, so that the error susceptibility can be reduced even further.

According to a further, preferred aspect of the invention, a measured distance can be compared by the control unit for each scanning cycle with a predetermined distance depending on the current position of the treatment device or a reference value, respectively, and a ‘sensor covered’ event can be output if the difference between the measured distance and the predetermined distance exceeds a predetermined threshold value; and a ‘not covered’ event can be output if the difference between the measured distance and the predetermined distance is within the predetermined threshold value. Minor measurement inaccuracies can be compensated in this way when using distance measuring sensors.

A further aspect of the invention relates to a method for evaluating an optical sensor for collision monitoring, which monitors a lateral boundary of a maximum treatment area of a vehicle treatment system with a predetermined scanning frequency, comprising at least the following steps:
continuously evaluating the individual output values of the sensor per scanning cycle;
incrementing a counter if the evaluated value suggests the presence of an obstacle;
resetting the counter if the evaluated value does not suggest an obstacle; and
outputting an obstacle warning and, if necessary, initiating collision avoidance measures when the counter reaches a certain threshold value (i.e. when a value has been detected in a predetermined number of consecutive scanning cycles that suggests the presence of an obstacle).

BRIEF DESCRIPTION OF THE DRAWING FIGURES

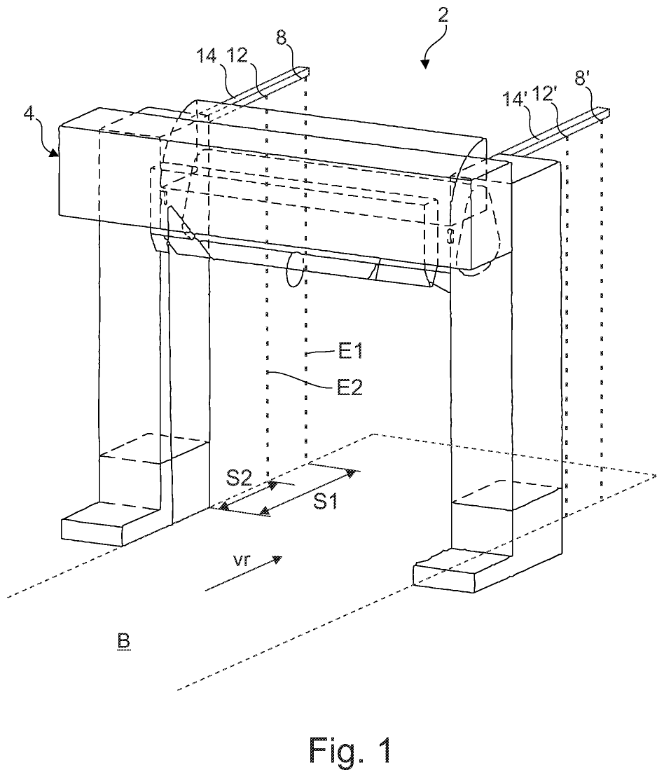

FIG. 1 is a perspective view of a vehicle treatment system with a sensor array for collision monitoring;

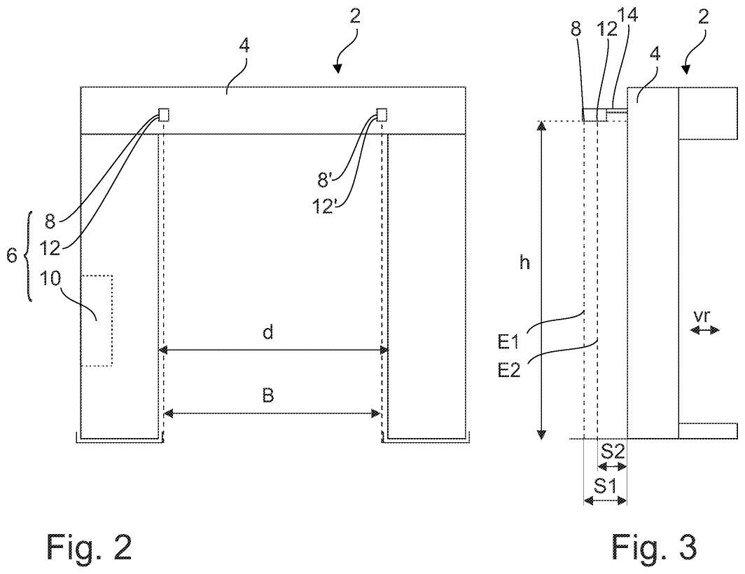

FIG. 2 is a front view of a vehicle treatment system with a sensor array for collision monitoring according to a first exemplary embodiment;

FIG. 3 is a side view of a vehicle treatment system with a sensor array for collision monitoring according to the first exemplary embodiment;

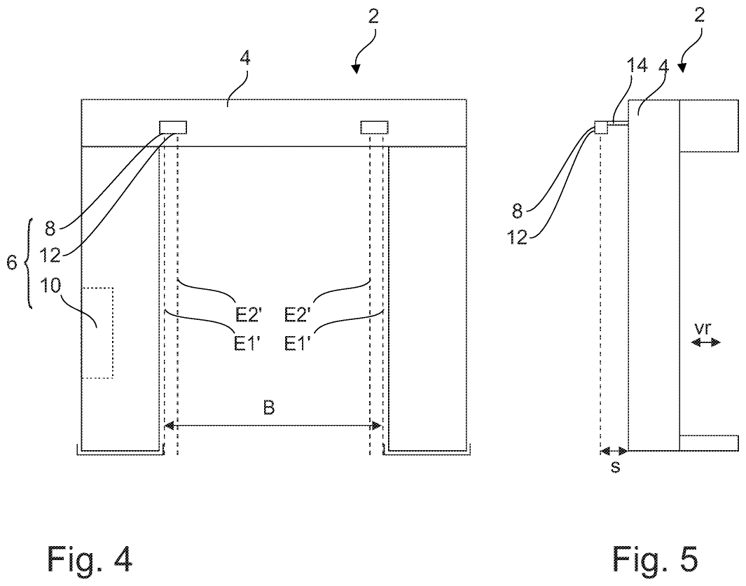

FIG. 4 is a front view of a vehicle treatment system with a sensor array for collision monitoring according to a second exemplary embodiment;

FIG. 5 is a side view of a vehicle treatment system with a sensor array for collision monitoring according to the second exemplary embodiment;

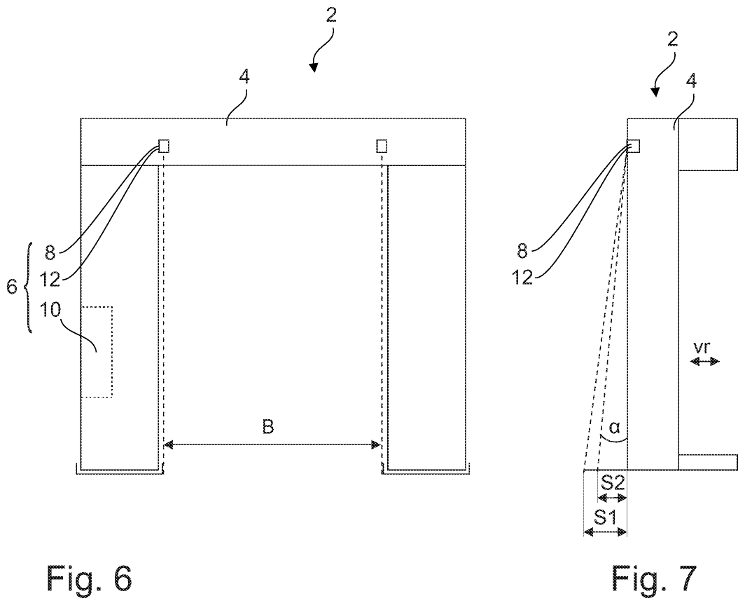

FIG. 6 is a front view of a vehicle treatment system with a sensor array for collision monitoring according to a third exemplary embodiment;

FIG. 7 is a side view of a vehicle treatment system with a sensor array for collision monitoring according to the third exemplary embodiment; and

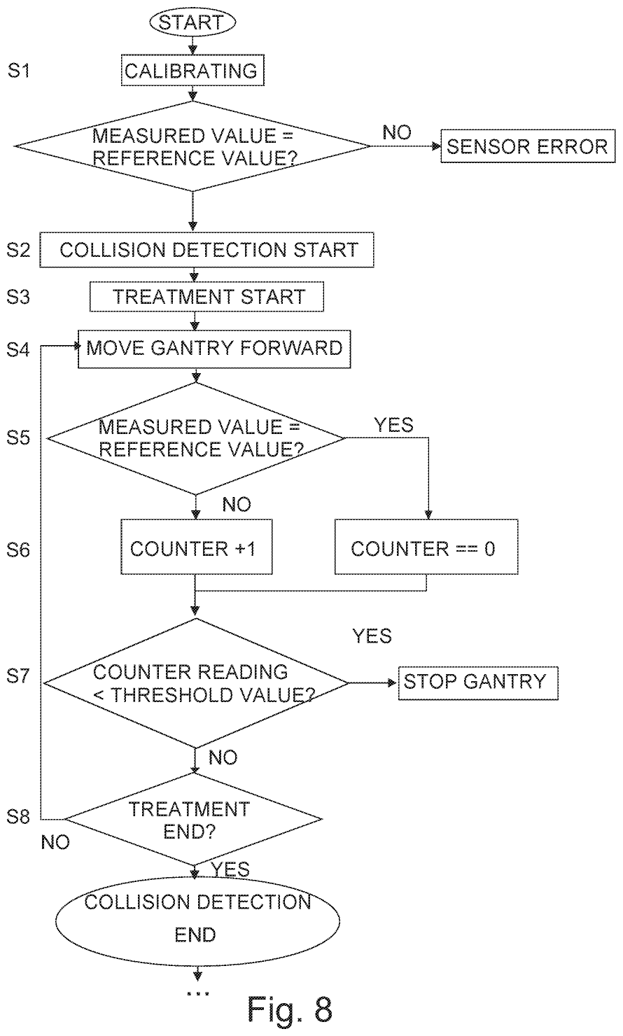

FIG. 8 is a schematic flowchart of a collision detection control for a first optical sensor.

### DETAILED DESCRIPTION

FIG. 1 is a perspective view of a vehicle treatment system (gantry wash system) 2 according to a preferred embodiment of the invention with a treatment device (washing gantry) 4 movable relative to a vehicle to be treated (washed) in a direction of relative movement yr. Such vehicle treatment systems 2 usually have a collision detection device 6 (see FIG. 2) for monitoring the boundaries of the maximum treatment space B. This collision detection device 6 is designed to avoid a possible collision of the vehicle treatment system 2 with the vehicle to be treated. In the vehicle treatment system 2 of the gantry wash system type shown here, the maximum treatment space B, in which a collision with a vehicle parked in it is not to be expected, results from a projection of the inner edges or flanks of the gantry in the direction of relative movement yr.

In the preferred embodiment shown in FIG. 1, such a collision detection device 6 is implemented in the form of contactless width monitoring of the vehicle treatment system 2. This device monitors in particular the lateral boundaries of the maximum treatment space B. It ensures that a parked vehicle does not collide with the inner edges or flanks of the gantry columns of the treatment device 4 or with treatment equipment, such as brushes and the like, which protrude beyond these columns towards the center of the treatment space.

If the collision detection device 6 detects that a section of a parked vehicle protrudes beyond the lateral boundaries of the maximum treatment space B and consequently a collision is imminent if the treatment device 4 or the vehicle continues to move forward, it causes the relative movement between the treatment device 4 and the vehicle to be stopped by stopping the treatment device 4.

Pre-evaluations by the Applicant have shown that laser distance sensors, which not only indicate the presence of an obstacle but also determine the absolute distance to it, are in theory particularly suitable for implementing contactless width monitoring. Laser distance sensors offer the possibility to block out specific areas, in which an obstacle is consequently ignored. This makes it possible to ignore irregularities in the ground, wheel guide rails or similar fixed irregularities. In practice, laser distance sensors have not been used for collision monitoring in vehicle treatment systems so far, mainly due to their sensitivity to spray mist. The noise signal generated by spray mist has proven to be very similar in quality and time to the useful signal of a reference obstacle, so that a reliable evaluation seemed impossible so far.

The sensors on which the collision detection device 6 shown in FIG. 1 is based combine two laser distance sensors a first laser distance sensor 8 and a second laser distance sensor 12 —in a certain arrangement to each other, so that a redundancy is created and the susceptibility to interference is reduced. The detection regions of the first laser distance sensor 8 and of the second laser distance sensor 12 (viewed from above) are in line with the lateral boundary of the maximum treatment area B to be monitored. In FIG. 1, the sensors 8, 12 are mounted on a cantilever arm 14 on the treatment device 4 (or its cross beam) and in line with the monitored inner edge of the gantry column. The advance of the first laser distance sensor 8 and of the second laser distance sensor 12 generated by the cantilever arm 14 is designed according to the required stopping distance of the treatment device 4 plus a safety reserve. The detection regions E1, E2 of both laser distance sensors 8, 12 are preferably oriented parallel to the inner edge of the treatment device 4 (vertically, perpendicular to the direction of relative movement). The advance S1 of the first laser distance sensor 8 is higher than the advance S2 of the second laser distance sensor 12. In the preferred exemplary embodiment of FIG. 1, the two laser distance sensors 8, 12 are therefore successively arranged in the longitudinal direction of the cantilever arm and measure vertically downwards.

In the embodiment of FIG. 1 and also in the further embodiments, naturally both lateral boundaries of the maximum treatment area are monitored. A second sensor array 8′, 12′ is provided on a second cantilever arm 14′. In order to avoid unnecessary repetition, only the sensors for monitoring a single lateral boundary will be described in the following.

The collision detection device 6 of the vehicle treatment system 2 of FIG. 1 has a control unit 10 (not shown in FIG. 1) for evaluation of the sensor output values of the two laser distance sensors 8, 12.

For the evaluation of the sensor output values, the following method is used in the sensor array of FIG. 1:
The signals of both sensors 8, 12 are evaluated continuously (double the scanning rate compared to the switching frequency of the sensors).
If the first laser distance sensor 8 detects an obstacle in a switching cycle (if a sensor measures a shorter distance than expected), a ‘sensor covered’ event is output for this cycle.
The control unit 10 adds the number of consecutive ‘sensor covered’ events for the first laser distance sensor 8 and stores them in a temporary memory/counter.
If there is no ‘sensor covered’ event at the first laser distance sensor 8 during a switching cycle, the temporary memory/counter of this sensor is reset to zero.
If a predetermined threshold value is exceeded in consecutive cycles with ‘sensor covered’ events, the control unit 10 detects an impending collision at the first laser distance sensor 8 (the threshold value or the required number of consecutive cycles with ‘sensor covered’ events is a parameter for adjusting the sensitivity of the sensors).
The same method is used with the second laser distance sensor. However, the number of ‘sensor covered’ cycles required for an obstacle detection is reduced by the number of cycles corresponding to the absolute distance of the detection regions of the sensors to each other.

In the collision detection device 6 of the embodiment shown in FIG. 1, a further refined evaluation method is used in which the signals obtained from the sensors 8, 12 are additionally evaluated as a function of the current gantry speed. The gantry speed can either be present directly or can be determined on the basis of an absolutely measured path length. The signals of the laser distance sensors 8, 12 are linked to the gantry speed as follows: the slower the treatment device (the gantry 4) moves, the more successive cycles with ‘sensor covered’ events are necessary for the control unit 10 to recognize an approaching obstacle (the threshold value is inversely proportional to the gantry speed).

FIGS. 2 and 3 represent an embodiment corresponding to the embodiment in FIG. 1 in a front and a side view. The maximum treatment area in FIG. 2 is chosen to maintain a certain safety distance from the actual clearance d between the inner surfaces of the gantry columns.

FIGS. 4 and 5 show a second embodiment of a sensor array according to the invention for a collision detection device 6 in a vehicle treatment system 2. As with the embodiment of FIGS. 1 to 3, the sensors are suspended from a cantilever arm 14 and at a predetermined advance s to the treatment device 4. In this embodiment, the first optical sensor 8 and the second optical sensor 12 have the same distance s to the treatment device 4 when viewed in the direction of relative movement. Instead, the two sensors 8, 12 are arranged with a certain offset in the width direction of the vehicle treatment system, so that the first optical sensor 8 measures along the boundary of the maximum treatment area B, while the detection region E2 of the second optical sensor 12 is offset inwards towards the center of the treatment area.

The following method is used to evaluate the sensor outputs of this sensor array:
The signals of both sensors 8, 12 are continuously evaluated (double scanning rate compared to the switching frequency of the sensors).
If ‘sensor covered’ events are received from the outer, first optical sensor 8, they are counted in a temporary memory/counter.
If ‘sensor covered’ events are received from the inner, second optical sensor 12, they are counted in a temporary memory/counter.
If there is no ‘sensor covered’ event on a sensor in one cycle, its counter is reset.
If a counter of a sensor exceeds an adjustable, in particular speed-dependent, threshold value, a ‘covered’ report is made.

If two ‘covered’ reports are present at the same time (at both sensors 8, 12), an obstacle is reported.

The embodiment of FIGS. 6 and 7 corresponds to the embodiment of FIGS. 1 to 3 in that the detection regions El, E2 of the first and second optical sensor 8, 12 are oriented along the lateral boundary of the maximum treatment area B and with differently defined advances relative to the treatment device 4 in the direction of relative movement. Accordingly, the evaluation of the measurement results is analogous to the embodiment of FIGS. 1 to 3. However, in the exemplary embodiment of FIGS. 6 and 7, the advance is not generated by a cantilever arm 14. Instead, both sensors are positioned at the height of the gantry cross beam and their detection regions E1, E2 are angled at a certain angle a to the front surface of the treatment device 4 to generate the advance. This has the advantage that a cantilever arm 14 is no longer needed and that the sensors 8, 12 fit even more unobtrusively into the gantry. The disadvantage is that the advance of the two sensors in such an arrangement depends on the height of an obstacle. If the obstacle is very high, the stopping distance of the treatment device could be too short in extreme cases. This can be counteracted by making the threshold value for a ‘covered’ report at sensors 8, 12 additionally dependent on the measured height, i.e. the shorter the detected distance is, the lower the threshold value of the consecutive measuring cycles with ‘covered’ event at the respective sensor 8, 12 could be.

It goes without saying that also in the embodiment of FIGS. 4 and 5, the arrangement of sensors 8, 12 on a cantilever arm 14 can be replaced by inclined/aligned sensors 8, 12. Mixed arrangements for generating the advance with respect to the treatment device 4 are also considered.

FIG. 8 shows another example of a possible control for a collision detection device 6 of a washing gantry 4. For the sake of clarity, the procedure is only shown for the first optical sensor 8. At the beginning of the vehicle treatment, the first optical sensor 8 is calibrated by measuring the distance to the floor of the vehicle treatment system 2 and comparing the measured distance with a stored reference value (S1). Afterwards, the vehicle treatment (S2) starts and the washing gantry 4 starts treating the vehicle (S3). Depending on the selected treatment program, the washing gantry 4 is moved during the treatment at a certain speed profile relative to a vehicle to be treated (S4). While the gantry 4 is moving, the first optical sensor 8 continuously measures the distance h to the ground at a predetermined switching frequency. For each cycle of the switching frequency, the first optical sensor 8 outputs a distance value. For different positions of the gantry 4, different reference values href can be used, e.g. to ignore/block out fixed unevenness of the floor (guide rails etc.). If the first optical sensor 8 measures in one cycle a distance which differs from the reference value href or which is shorter than the reference value href by more than a given tolerance value, the control unit 10 detects a ‘sensor covered’ event for this cycle and a counter of the first optical sensor 8 is incremented. However, if the first optical sensor 8 measures in one cycle a distance which corresponds to the reference value href or which differs from the reference value href by less than the specified tolerance value, the counter of the first optical sensor 8 is reset to zero (S6). In a next step (S7), it is checked whether the counter reading exceeds a predetermined threshold value. If the threshold value is exceeded, a control signal (collision detected) is sent to a drive control of the vehicle treatment system to stop the washing gantry, otherwise the movement of the gantry 4 is continued and the next measuring cycle of the sensor is evaluated. If the end of the treatment is reached, the collision detection control/routine is terminated.

According to a preferred configuration example, the evaluation of the measurement results (S4 to S6) of the first optical sensor 8 described above is applied in parallel to a (redundant) second optical sensor 12. In this case, the evaluation step S7 can be adapted in an advantageous way and a collision is detected if the counter reading of the first optical sensor 8 and the counter reading of the second optical sensor 12 exceed the threshold value in the same measuring cycle.

It goes without saying that the preceding invention described in the concrete example of a gantry wash system is also applicable to vehicle treatment systems in which a vehicle is guided relative to stationary treatment devices, e.g. via a carrier. In such a case, the clearance/collision-free space is also defined by projection of the inner edges/inner contours of the treatment device in the direction of the relative movement, even if no actual movement of the treatment device takes place.

Deviating from the exemplary embodiment described above, an additional or alternative backward facing sensor can be used to detect impending collisions.

1. A vehicle treatment system comprising at least one treatment device that is movable relative to a vehicle to be treated the vehicle treatment system having a collision detection device for width monitoring of a maximum treatment area of the vehicle treatment system, which, for monitoring a lateral boundary of a maximum treatment area, has at least one first optical sensor, which is operated during a treatment process at a predetermined scanning frequency and outputs an output value for each scanning cycle, and a control unit for evaluating output values of the at least one first optical sensor,
a first detection region of the at least one first optical sensor being arranged in an advanced manner or ahead by a first predetermined distance along a lateral boundary to be monitored of the maximum treatment area of the vehicle treatment system and the at least one treatment device in a direction of relative movement, and
the control unit evaluates each output value of the at least one first optical sensor either with a first sensor covered event or with a first sensor not covered event and then detects an impending collision if a first predetermined number of consecutive cycles with the first sensor covered event is detected at the at least one first optical sensor.

2. The vehicle treatment system according to claim 1, wherein the first detection region of the at least one first optical sensor is fixedly oriented and lies within a plane which is spanned between an inner edge of the at least one treatment device facing the treatment space and the direction of relative movement.

3. The vehicle treatment system according to claim 1, wherein
the collision detection device comprises a second optical sensor having a second detection region that is arranged or oriented at a predetermined distance and/or angle relative to the at least one first optical sensor; and
the control unit evaluates output values of the second optical sensor either with a second sensor covered event or with a second sensor not covered event and then detects an impending collision at the lateral boundary of the maximum treatment area monitored by the at least one first optical sensor and by the second optical sensor if, within a predetermined period of time, a the first predetermined number of consecutive cycles with the first sensor covered event is scanned at the at least one first optical sensor and a second predetermined number of consecutive cycles with the second sensor covered event is scanned at the second optical sensor.

4. The vehicle treatment system according to claim 3, wherein the second detection region of the second optical sensor is oriented along the lateral boundary of the maximum treatment area and is arranged in front of or ahead of the at least one treatment device in the direction of relative movement by a second predetermined distance, wherein the second predetermined distance of the second optical sensor is less than the first predetermined distance of the at least one first optical sensor.

5. The vehicle treatment system according to claim 3, wherein the second detection region of the second optical sensor is arranged at a level of the first detection region of the at least one first optical sensor, viewed in the direction of relative movement of the at least one treatment device, and, viewed from the first detection region of the at least one first optical sensor, is offset inwards by a third predetermined distance towards a center of the maximum treatment area.

6. The vehicle treatment system according to claim 4, wherein the second predetermined number of consecutive cycles is less than the first predetermined number of consecutive cycles.

7. The vehicle treatment system according to claim 5, wherein the control unit is configured to detect an impending collision if a number of first sensor covered events and second sensor covered events is present simultaneously at the at least one first optical sensor and at the second optical sensor and wherein the number is greater than or equal to a threshold value for reporting the impending collision.

8. The vehicle treatment system according to claim 3, wherein the at least one first optical sensor and the second optical sensor are arranged in such a way that the at least one first optical sensor and/or the second optical sensor is arranged on a cantilever arm and/or is inclined in a travel direction away from the at least one treatment device in order to achieve a predetermined advance rate in the direction of relative movement.

9. The vehicle treatment system according to claim 4, wherein the at least one first optical sensor and/or the second optical sensor is a laser distance sensor.

10. The vehicle treatment system according to claim 9, wherein
for each scanning cycle, a first distance measured by the at least one first optical sensor is compared to the first predetermined distance, or a second distance measured by the second optical sensor is compared to the second predetermined distance;
the control unit detects the first sensor covered event for each scanning cycle if a first difference between the first distance and the first predetermined distance exceeds a predetermined threshold value or detects the second sensor covered event for each scanning cycle if a second difference between the second distance and the second predetermined distance exceeds the predetermined threshold value; and
a first sensor not covered event or a second sensor not covered event for the respective scanning cycle is detected if the first difference or the second distance is less than or equal to the predetermined threshold value.

11. A method for operating a vehicle treatment system according to claim 4, comprising the steps of:
evaluating the output values of the at least one first optical sensor per scanning cycle by the control unit as either the first sensor covered event or the first sensor not covered event;
detecting of an impending collision if the first predetermined number of consecutive cycles with the first sensor covered event is detected at the at least one first optical sensor.

12. The method for operating a vehicle treatment system according to claim 3, comprising the steps of:
evaluating the output values of the at least one first optical sensor by the control unit as either the first sensor covered event or the first sensor not covered event;
evaluating the output values of the second optical sensor by the control unit as either the second sensor covered event or the second sensor not covered event;
detecting an impending collision at the lateral boundary of the maximum treatment area monitored by the at least one first optical sensor and the second optical sensor if within the predetermined period of time the first predetermined number of consecutive cycles with the first sensor covered event is scanned at the at least one first optical sensor and the second predetermined number of consecutive cycles with the second sensor covered is scanned at the second optical sensor.

13. The method according to claim 11, wherein the first predetermined number of consecutive cycles with the first sensor covered event, or the second predetermined number of consecutive cycles with the second sensor covered event, increases as a rate of relative movement between the at least one treatment device and the vehicle to be treated decreases, and
the first predetermined number of consecutive cycles with the first sensor covered event, or the second predetermined number of consecutive cycles with the second sensor covered event, decreases as the rate of relative movement between the at least one treatment device and the vehicle to be treated increases.

14. The method according to claim 12, wherein the second predetermined number of consecutive cycles with the second sensor covered event is less than the first predetermined number of consecutive cycles with the first sensor covered event.

15. The method according to claim 11, wherein
the at least one first optical sensor and/or the second optical sensor is a laser distance sensor, and
for each scanning cycle, a first distance measured by the at least one first optical sensor is compared to the first predetermined distance, or a second distance measured by the second optical sensor is compared to the second predetermined distance;
the control unit detects the first sensor covered event for each scanning cycle if a first difference between the first distance and the first predetermined distance exceeds a predetermined threshold value, or detects the second sensor covered event for each scanning cycle if a second difference between the second distance and the second predetermined distance exceeds the predetermined threshold value.
